(19) United States
(12) Patent Application Publication
(10) Pub. No.: US 2009/0063201 A1
(43) Pub. Date: Mar. 5, 2009

(54) SoberTeenTM Driving Insurance

(76) Inventors: Mark S. Nowotarski, Stamford, CT (US); Donald Bashline, Watertown, MA (US)

Correspondence Address: Markets, Patents & Alliances LLC, 30 Glen Terrace, Stamford, CT, 06906-1401, US

(21) Appl. No.: 12/266,657

(22) Filed: Nov. 7, 2008

Related U.S. Application Data
(60) Provisional application No. 61/104,708, filed on Oct. 11, 2008.

(51) Int. Cl. G06Q 40/00

(52) U.S. Cl. 705/4

(57) ABSTRACT

Drunk driving causes terrible misery. A new type of auto insurance called SoberTeen™ Driving insurance may help that. SoberTeen driving insurance is auto insurance that provides a 10% to 30% discount to young drivers who always drive sober and are willing to let an insurance company monitor their cars to verify it. Intoxication can be determined from measuring braking force, accelerator use and proximity to nearby cars. A “nonintrusive load monitor” algorithm can figure out if a driver is intoxicated, even if different drivers use the car. The insurance product may be set up so that the policy premium is based on monitoring a young driver during a one month probationary period, but there is no actual monitoring during the next year of insurance coverage. That way, driver privacy is protected.

### CROSS REFERENCE TO RELATED APPLICATION

The patent application claims priority to U.S. provisional patent application Ser. No. 61/104,708 entitled “SoberTeen™ Driving Insurance”, filed on Oct. 11, 2008. Said provisional application is incorporated herein by reference.

### FIELD OF INVENTION

This invention is in the field of auto insurance.

### NOTE TO PEER TO PATENT REVIEWERS

This patent application has been drafted with a style and format tailored for Peer-to-Patent reviewers. The tone is conversational and the “claims” are in common language so that those who are not familiar with patents can readily understand them.

Thank you for your thoughtful input.

### BACKGROUND

temperance n. Moderation and self restraint in behavior.

Drunk driving takes a horrible toll on our society, particularly among young drivers (FIG. 1). It accounts for half of the 50,000 traffic deaths every year in the US and devastates every family it touches. This patent application proposes a new insurance product and associated technology that may help address this issue.

### SUMMARY OF THE INVENTION

Young drivers (and their parents) will earn substantial discounts on their auto insurance if they agree to have their driving performance analyzed by a special program called a “Non-Intrusive Load Monitor” (NILM). No new equipment is needed. The NILM program can be uploaded into a car's engine control computer. The results can be shared with the young driver through the car's telecommunication system (e.g. OnStar®).

The NILM program will constantly monitor driving performance (FIG. 2) to identify high risk factors such as:

Driving while intoxicated

Driving while using a cell phone

Driving while fatigued

Driving while emotionally distraught

There is no need to share any of this information with the insurance company. The young driver will be presented with a periodic “Safe Driver” report detailing when high risk driving occurred and the likely cause of it. Each report will be coded with a self verifying ID number. If the young driver inputs the self verifying ID number into the insurance company's web site, then the insurance company will know that the young driver has been presented with the report and the driver will earn the discount. An additional discount can be earned if parents review the report as well (FIG. 3).

### FIGURES

FIG. 1 illustrates the human toll of drinking and driving.

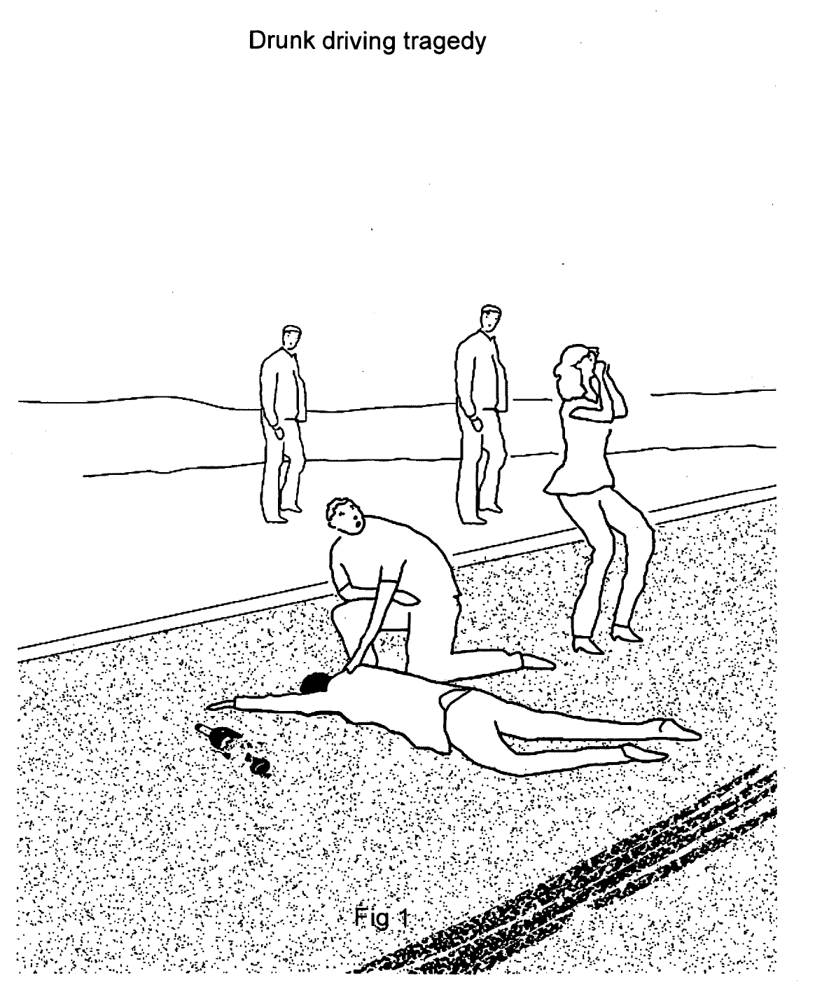

FIG. 2 illustrates the difficult choices that a young driver must make, and the benefit of having a car monitor to help encourage the young driver to make responsible choices.

FIG. 3 illustrates the benefit to both a parent and young driver reviewing “safe driver” reports.

FIG. 4 shows how a driver's dynamic braking characteristics change depending upon if the driver is intoxicated, sober, or using a cell phone. The figure is based on FIG. 3 from Strayer et al., “A Comparison of the Cell Phone Driver and the Drunk Driver”, Working Paper 04-13, July 2004, [http://www.hfes.org/Web/Pubpages/celldrunk.pdf] (Strayer et al.). Said paper is incorporated herein by reference.

### DETAILED DESCRIPTION

One of the most significant risk factors in young driver accidents is drinking and driving.

### Determining When a Driver is Intoxicated

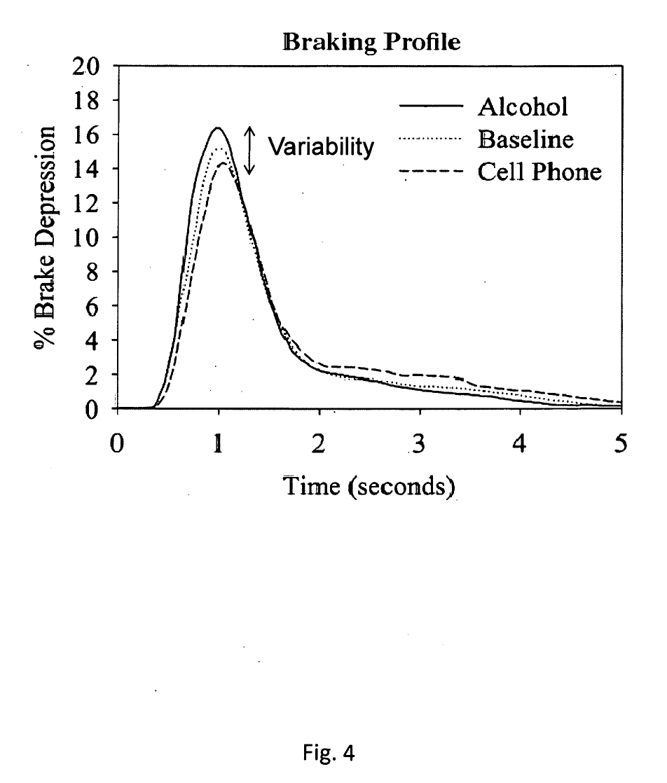

A driver's behavior changes when he or she is intoxicated. According to research by Dr. David Strayer of the University of Utah, drivers in stop-and-go traffic brake harder when they are legally drunk (blood alcohol level of 0.08%) than when they are sober. The difference in braking force is about 10% on average and is statistically significant to at least the 99% confidence level (FIG. 4).

Braking is normally monitored by a car's engine control computer. The computer can be programmed, therefore, to detect when a driver is drunk by observing an increase in braking force for a given driving regime (e.g. stop-and-go).

There are many other reasons, however, why braking force might increase. These include changes in traffic conditions and changes in drivers. In order to tell if a driver is drunk, a driver monitor must be able to sift out these other causes. One way to achieve this is with an algorithm called “Nonintrusive Load Monitoring”.

### Nonintrusive Load Monitoring

Nonintrusive Load Monitoring (NILM) was developed by Dr. George Hart and his colleagues at MIT in the early 1980's as a way to create a “smart” electric meter for houses. The basic process is described in U.S. Pat. No. 4,858,141, “Non-intrusive appliance monitor apparatus”, [http://www.google.com/patents?id=gwg3AAAAEBAJ&dq=4,858,141], which is incorporated by reference.

The goal of Dr. Hart's work was to develop an electric meter that could analyze the changes in total electric power going into a house and determine what appliances were in the house, when they were used, and how much electricity they used.

I had the pleasure of visiting Dr. Hart and viewing the original NILM prototype running in his home. We went in the basement to watch the monitor and he called out to his wife to start turning things on and off upstairs. Sure enough, the monitor suddenly said “bathroom light on”, “living room fan off”, “refrigerator on” and so forth. The system did not know beforehand what sort of light bulbs, fans etc. there were in the house, or what their power consumption was. It figured that out by itself just by looking at changes in the total power draw.

The system could deduce the nature of an appliance from the characteristic signatures it created in the overall voltage and current going into the house. Signals could overlap in time and the system would still accurately keep track of which appliances were on or off. The system could discriminate between appliances that were nominally the same by sensing small but statistically significant differences in the characteristics of their energy consumption. It could even keep track of appliances as they aged. The system could keep track of the same light bulb, for example, as its resistance slowly increased over time. If the resistance suddenly changed, however, it knew that the light bulb had been replaced and would then keep track of the new light bulb as a separate entity.

The ability of the NILM system to discriminate between two different appliances was enhanced by its monitoring multiple electrical parameters at the same time. By simultaneously measuring actual power draw and reactive power draw, for example, it could discriminate between a fan and a light bulb, even if the two had exactly the same wattage. Fans have a large reactive power for a given wattage. Light bulbs have a very small reactive power for a given wattage. Reactive and actual power draw can be calculated from current and voltage waveforms and the phase lag between them.

NILM algorithms also employ cluster analysis in order to identify complex appliances that do more than simply turn on and off. Dishwashers, for example, have a motor, heater and one or more solenoids that turn on and off in a consistent manner during a typical wash cycle. By using cluster analysis, the NILM monitor could identify regularities in the cycles and record overall “dishwasher on” and “dishwasher off” as opposed to overly detailed “solenoid #1 on” (let water in), “heater #1 on” (heat water in dishwasher), “solenoid #1 off” (shut off water), “motor #1 on” (run the wash cycle), “solenoid #2 on” (open the door to the soap container), etc.

More details on the NILM algorithms can be found in Hart, G. W., “Nonintrusive Appliance Load Monitoring”, Proceedings of the IEEE, December 1992, pp. 1870-1891. [http://www.georgehart.com/research/nalm.html] Said publication is incorporated herein by reference.

### Using Nonintrusive Load Monitoring to Measure Driver Sobriety

Changes in driver sobriety can be observed by applying the NILM algorithms to one or more of the monitored parameters in the car. Braking force and braking time, for example, are two independent parameters that can be used to measure driver sobriety. The accuracy can be improved by using cluster analysis of braking frequency to determine different driving regimes (e.g. “stop-and-go”, “daily commute”, “around town”, “highway”). Additional accuracy can be achieved by monitoring additional parameters, such as speed, gas pedal position, steering dynamics, proximity to nearby cars (e.g. ultrasonic bumpers or blind spot monitoring systems), driver head and facial expressions (e.g. “Driver Attention Monitor” by Lexus). All of these parameters are commonly measured in cars and recorded by a car's engine control computer. The NILM algorithm can be uploaded into the engine control computer to analyze the parameters and determine driver sobriety. There are also retrofit systems, such as the “Cognitive Resources Availability Manager” by Effective Control Transport that can be used. [http://www.ecnholding.com]

Car data can also be accessed through a car's OBD-II port. This is the electrical fitting that car mechanics use to diagnose what's wrong in a car. A non-intrusive load monitor could be plugged directly into the OBD-II port to measure sobriety.

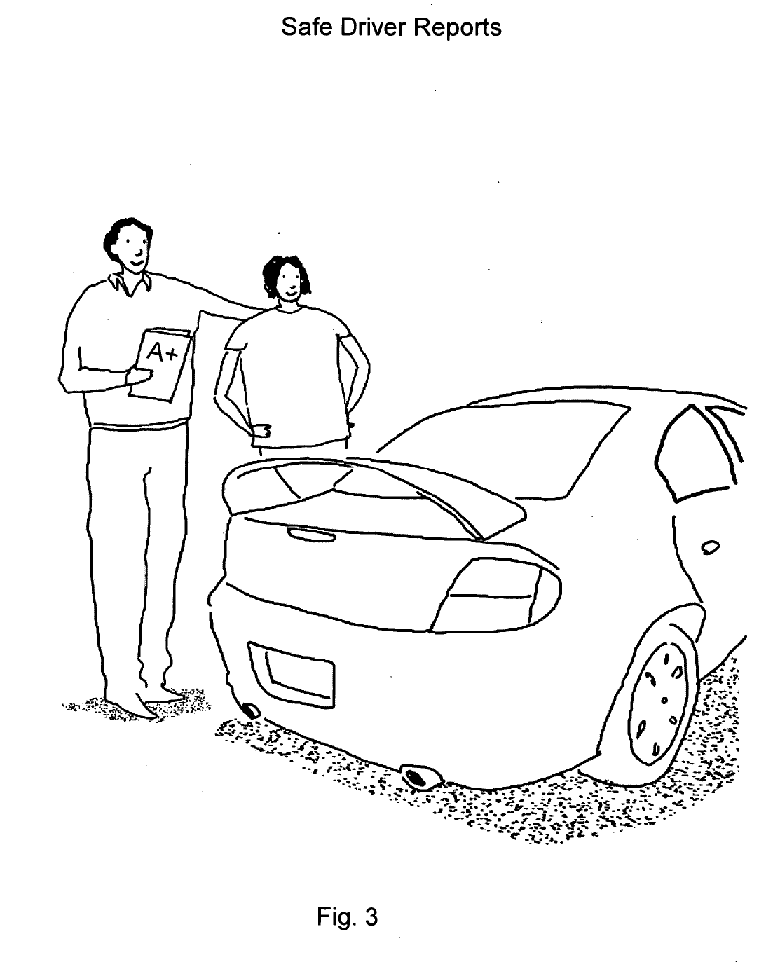

Other forms of driver impairment, such as cell phone use, drowsiness, seizures, etc., can be identified with the NILM algorithm. Dr. Strayer's work, for example, showed that cell phone use causes different changes in braking behavior than intoxication. This is illustrated in FIG. 4. FIG. 4 is based on FIG. 3 of Strayer et al. Braking force in stop-and-go traffic tended to decrease with cell phone use, and increase with intoxication.

### Insurance Product Design

Designing a practical insurance product is difficult, particularly where privacy concerns and potentially illegal activity by the driver are involved. The insurance company has to accurately assess risk, but it must also respect the privacy of the people it insures while at the same time not condoning illegal activity.

One way to address this concern is for the insurance company to assert that the data will be used solely to determine the insured's eligibility for the discount. This can be backed up with a warranty that the insurer will destroy all of the data collected once the policy is over and the driver's eligibility for discount is discontinued.

Another way to address the privacy issue is to measure the riskiness of a driver's behavior without measuring the legality of a driver's behavior. This can be done by measuring a parameter directly associated with risk but not directly associated with a particular illegal behavior. For example, if the NILM system only measured the variability in braking force and not whether or not braking force increased or decreased, it would directly measure the combined risk due to intoxication and cell phone use, but would not know which particular illegal activity was being engaged in or even if any illegal activity at all was engaged in at all. Drowsiness, for example, may increase variability in braking force and also increase accident risk, but it is not an illegal behavior.

Another approach to measuring risk while still preserving a driver's privacy, is to monitor the driver only during an initial evaluation period to make a risk assessment and not during the actual period of insurance coverage. The rates for the actual period of insurance coverage would be based on the risk assessment made during the evaluation period. A teenage driver, for example, would initially be covered under his or her parent's policy. He or she would then agree to having his or her driving monitored for a one month evaluation period. If the results showed responsible, low risk driving, then a discount could be offered for the next year of insurance, but no monitoring would be done. Before the year is up, the driver could agree to have his or her driving monitored during another evaluation period and those results would be used to set the rate for the next year.

A detailed “Safe Driver” report based on the results of the monitoring might be given to the parents of the young driver along with an insurance risk classification and recommendations for changes in behavior that could lead to an improved risk score.

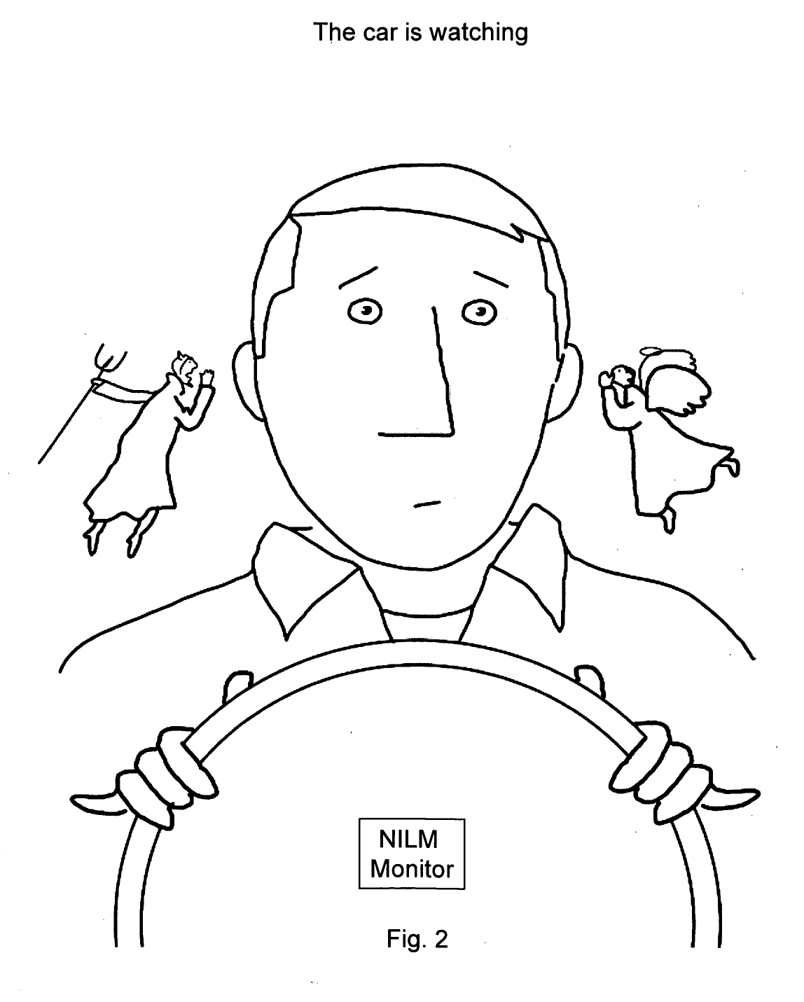

To further safeguard to a young driver's privacy, the Safe Driver report may be given only to the young driver. Young drivers may not recognize when they are impaired. The report would make it clear to them when risky behaviors were occurring. FIG. 2 illustrates the benefits to a young driver of having an in-car monitor to help him or her make responsible and mature choices.

Discounts can even be offered even if no driving information at all is shared with the insurance company. Safe Driver reports might be provided with unique self-verifying identification numbers, similar to the activation codes needed for software. If drivers and/or their parents input the Safe Driver report self-verifying numbers into an insurance company, the insurance company would only know that safe driving reports were looked at. It would not get any information about the actual driving. Nonetheless, the fact that the reports were looked at would be enough to identify those that reviewed the reports as a lower risk class of drivers. They could then be charged lower premiums. FIG. 3 illustrates the benefits to parents and young drivers of reviewing safe driving reports.

1. We claim that we have invented and adequately described a new auto insurance product where a driver receives a 10 to 30 percent discount in premium in exchange for allowing the insurance company to monitor his or her car to determine if anyone drives it while under the influence of alcohol.

2. We also claim that we have invented the insurance product described in claim 1 with the additional feature that the insurance company uses a NILM algorithm to determine if any of the drivers are drunk.

3. We claim that we have invented the insurance product of claim 2 where the NILM algorithm analyses at least two parameters of the car, such as the braking force and proximity to nearby cars.

4. We claim the insurance product of claim 3 where only the variability in braking force is observed for different driving regimes so that there is no way to tell if a particular illegal activity, such as intoxication or cell phone use, is engaged in, but you can still tell if the driver is a high risk driver.

5. We claim the insurance product of claim 1 where the insurance company agrees to destroy all records of a driver's monitored behavior once the driver's eligibility for a discount is determined.

6. We also claim that we have invented a new type of auto insurance product where a young driver agrees to have his or her driving monitored for at least a month and where the rates for the next year are based on the results of the monitoring.

7. We claim that we have invented the auto insurance product of claim 6 where the young driver and his/her parents are given a “Safe Driver” report based on the results of the monitoring.

8. And we claim that we have invented the auto insurance product of claim 7 where the only information that the insurance company gets is an indication that either the young driver and/or his/her parents have reviewed the safe driver report.
